(19) United States
(12) Patent Application Publication
(10) Pub. No.: US 2006/0221079 A1
(43) Pub. Date: Oct. 5, 2006

(54) Method and system for filling in a parallelogram

(75) Inventors: Qin Zhao, Charenton Le Pont (FR); Laurent Pasquier, Asnieres-Sur-Seine (FR); Marc Duranton, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V,, BA Eindhoven (NL)

(21) Appl. No.: 10/554,013

(22) PCT Filed: Apr. 15, 2004
(86) PCT No.: PCT/IB04/01209

§ 371 Date: Oct. 21, 2005

(30) Foreign Application Priority Data
Apr. 24, 2003 (FR) 0350126

(51) Int. Cl. G06T 11/20

(52) U.S. Cl. 345/441

(57) ABSTRACT

The invention relates to a method of tracing and filling in a parallelogram (ABCD), comprising a first vertex (A), a second vertex (B), a third vertex (C) and a fourth vertex (D) on a discrete grid of a graphics screen from knowledge of the coordinates of its vertices. The method according to the invention comprises a step (10) of calculating the coordinates of the points on a first segment (AB) between the first vertex (A) and the second vertex (B), a step (11) of calculating the coordinates of the points on a second segment (AC) between the first vertex (A) and the third vertex (C), a step (12) of calculating the coordinates of the points on a third segment (BD) between the second vertex (BD) and the fourth vertex D and an iterative step (20) of calculating the coordinates of the points on a segment parallel to the segment AB and included within the parallelogram ABCD. Advantageously, the steps of calculating coordinates of the points on a segment use a so-called mid-point algorithm or Bresenham's algorithm.

### FIELD OF THE INVENTION

The present invention relates to a method of filling in a parallelogram. It also relates to a system implementing such a method. Finally, it relates to a computer program implementing such a method.

It finds its application in particular in the fields of image synthesis, video games in two or three dimensions and the processing of video objects according to the MPEG-4 standard.

### BACKGROUND OF THE INVENTION

In the field of video games and more generally the synthesis of images, the problem is posed of displaying objects of interest with more or less complex shapes on a graphical screen comprising a discrete grid of points, commonly referred to as pixels in a two-dimensional space and voxels in a three-dimensional space. For this purpose, the objects of interest are decomposed into primary forms, generally triangles, which are traced and filled in on the discrete grid on the screen from knowledge of the coordinates of their vertices, allocating a texture value to them. One problem is therefore to make a point on the discrete grid correspond to a point on a primary shape having non-integer real coordinates. Techniques have been developed for managing this, the majority based on the principles of a so-called “mid-point” algorithm or Bresenham's algorithm. This algorithm, initially disclosed by the document of Jack E. Bresenham, entitled “Algorithm for Computer Control of a Digital Plotter” and published in the IBM Systems Journal, Volume 4(1), on pages 25-30 in 1965, in particular makes it possible to trace oblique segments rapidly and effectively. Such an algorithm is widely used in the field of image synthesis. Other techniques, also well known to persons skilled in the art, have subsequently been derived from this algorithm for filling in triangles or even polygons.

These techniques have the common feature of proposing a filling in of a triangle, or even a polygon, by horizontal or vertical scanning. One type of triangle well adapted to such a scanning is a triangle comprising a line segment, that is to say horizontal or vertical. FIG. 1 depicts a triangle IJK, a segment JK of which is horizontal. In this case, the filling in of such a triangle comprises the following steps:

a step of tracing the segment IJ according to Bresenham's algorithm. This step is intended to calculate the coordinates of the points Jᵢ of the segment Ij in a reference frame (Jₓ, J_{y}). Knowing these coordinates, it is then possible to trace these points and to allocate a texture value to them,

a step of tracing the segment IK according to Bresenham's algorithm. This step is intended to calculate the coordinates of the points Kᵢ of the segment IK in the reference frame (Jₓ, J_{y}),

a step of horizontal scanning of the triangle IJK intended to travel over a region of interest RI comprising the triangle, a test step for testing whether a point on said region RI belongs to the triangle IJK by means of the coordinates of the points of the segments IJ and IK. For example, a point P situated on the segment JᵢKᵢ belongs to the triangle IJK if its abscissa x_{P} is such that x_{Ji}<x_{P}<x_{Ki}.

One advantage of this method is being rapid and of low complexity. This is because Bresenham's algorithm can be implemented using only integers and additions. It is therefore well suited to hardware implementation, which is particularly advantageous in the field of video games. This is because, in this field, the objects of interest undergo more and more complex processing which, in order to be carried out in real time, is implemented by processors specially designed to accelerate regular calculations such as for example the tracing of an oblique segment between two known points.

Such a method is also advantageously used in the field of video compression, in particular by the MPEG-4 standard (“Motion Picture Expert Group”). This is because this standard has the particularity of considering an object of interest in a video sequence independently of the background of this sequence. Such an object comprises a shape and a texture, which are encoded separately. The shape is encoded by means of a bounding box, generally rectangular. The filling in of this shape within the box is also done using Bresenham's algorithm.

However, it is clear that, though an object of interest in a video game scene can always be decomposed into a mosaic of triangles, a video scene often contains a large number of parallelograms. This is because a rectangular shape, very widespread in two dimensions, becomes a parallelogram in a perspective view in three dimensions.

The bounding box used in the MPEG-4 standard is subjected to the same types of transformations and becomes a parallelogram in a perspective view.

Though two triangles with a line segment suffice to describe a rectangle, at least four are necessary for a parallelogram. A parallelogram is therefore represented by the descriptions of four triangles and the concatenation of these triangles. Such a representation is complex, expensive in terms of memory space and not very practical to use, when it is a case of tracing and filling in this parallelogram on a graphical screen.

### SUMMARY OF THE INVENTION

The aim of the present invention is to propose a solution for tracing and filling in a parallelogram in a more simple and rapid fashion, using only the coordinates of these four vertices.

This aim is achieved by a method of filling in a parallelogram comprising a first vertex, a second vertex, a third vertex and a fourth vertex, said method comprising:

a step of calculating the coordinates of a first segment between the first vertex and the second vertex,

a step of calculating the coordinates of a second segment between the first vertex and the third vertex,

a step of calculating the coordinates of a third segment between the second vertex and the fourth vertex,

an iterative step of calculating the coordinates of a segment parallel to the first segment and included within the parallelogram.

The method according to the invention makes it possible to calculate the coordinates of the points situated within a parallelogram from the coordinates of its four vertices, and therefore to trace it and fill it in without having to decompose it into several triangles. Said method consists of tracing a first segment of the parallelogram and then tracing second and third segments, parallel to each other and situated on each side of the first segment, and finally tracing all the possible parallels to the first segment contained between the second and third segments.

In a first embodiment, the iterative step of calculating the coordinates of a segment parallel to the first segment consists of choosing a point on the second segment and a point on the third segment, such that the two points are situated at equal distances respectively from the first and second vertex in a favored horizontal or vertical direction, and calculating the coordinates of the points of the segment lying between these two points.

Advantageously, the various steps of calculating the coordinates of the points on a segment use Bresenham's algorithm, also referred to as the mid-point algorithm, since it makes it possible to trace an oblique segment between two points simply and rapidly.

By providing the coordinates of the points included in the parallelogram solely from the knowledge of its four vertices, the method according to the invention avoids decomposing the parallelogram into triangles and makes it possible to save on memory space. This is because, instead of the vertices of all the triangles and a representation of the concatenation of these triangles within the parallelogram, only the coordinates of the four vertices must be stored in memory.

In a second embodiment, the iterative step of calculating the coordinates of a segment parallel to the first segment consists of translating the first segment in a favored direction by a certain increment within the parallelogram. Knowing the increment, the coordinates of the points on the translated segment obtained are easily deduced from those of the first segment. The operation is renewed so as to cover the entire surface of the parallelogram.

A major advantage of the second embodiment is to provide an exhaustive filling in of the parallelogram, that is to say without any hole. Translating a segment does not cause any accumulation of errors. On the contrary, placed side by side, the translated segments fit together perfectly, since they are identical.

### BRIEF DESCRIPTION OF THE DRAWINGS

The invention will be further described with reference to examples of embodiments shown in the drawings to which, however, the invention is not restricted.

FIG. 1a illustrates the filling in of a triangle having a straight edge according to the prior art,

FIG. 1b illustrates the filling in of a parallelogram according to the invention,

FIG. 2a presents a functional diagram of the method of filling in a parallelogram according to the invention,

FIG. 2b illustrates an example of filling in a parallelogram according to a first embodiment of the invention,

FIGS. 3a and 3b illustrate the principle of Bresenham's algorithm for tracing an oblique segment on a discrete grid,

FIG. 4 presents a functional diagram of the first embodiment of the invention,

FIG. 5 illustrates the formation of holes during the filling in of the parallelogram according to the first embodiment of the invention,

FIG. 6 presents a functional diagram of the second embodiment of the invention,

FIGS. 7a and 7b illustrate an example of the filling in of a parallelogram according to a second embodiment of the invention,

FIG. 8 illustrates the principle of a method of calculating the coordinates of the point E according to the second embodiment of the invention.

### DESCRIPTION OF PREFERRED EMBODIMENTS

The method according to the invention relates to the filling in of a parallelogram on a discrete grid on a graphics screen. Said method applies equally well both to a two-dimensional representation and to a three-dimensional representation. Hereinafter, only the case with two dimensions is described. However, the extension to the case with three dimensions would not pose any particular problem for a person skilled in the art.

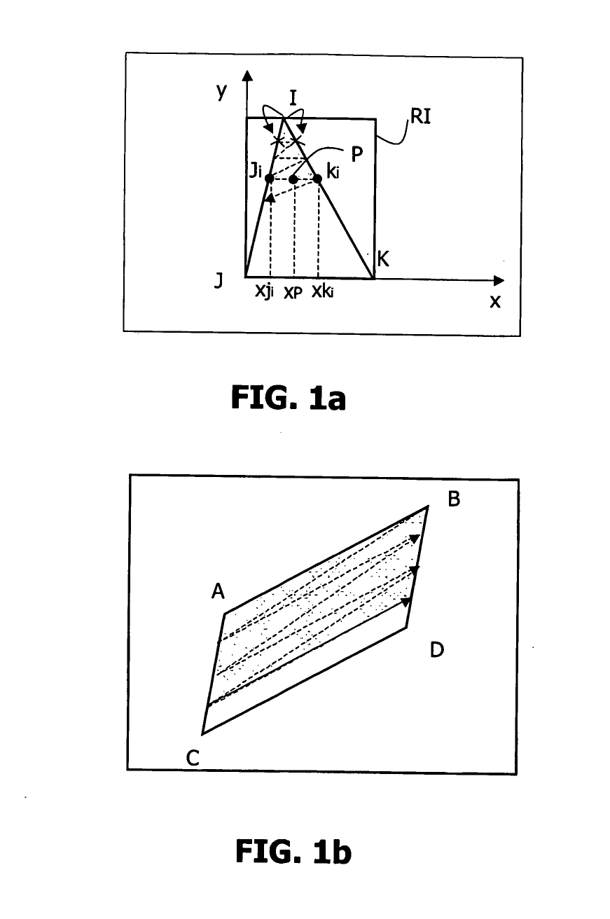

FIG. 1b depicts an example of the filling in of a parallelogram ABCD according to the invention solely from the knowledge of its first vertex A, its second vertex B, its third vertex C and its fourth vertex D. The filling in is done by successive scannings of the parallelogram ABCD parallel to the first segment AB.

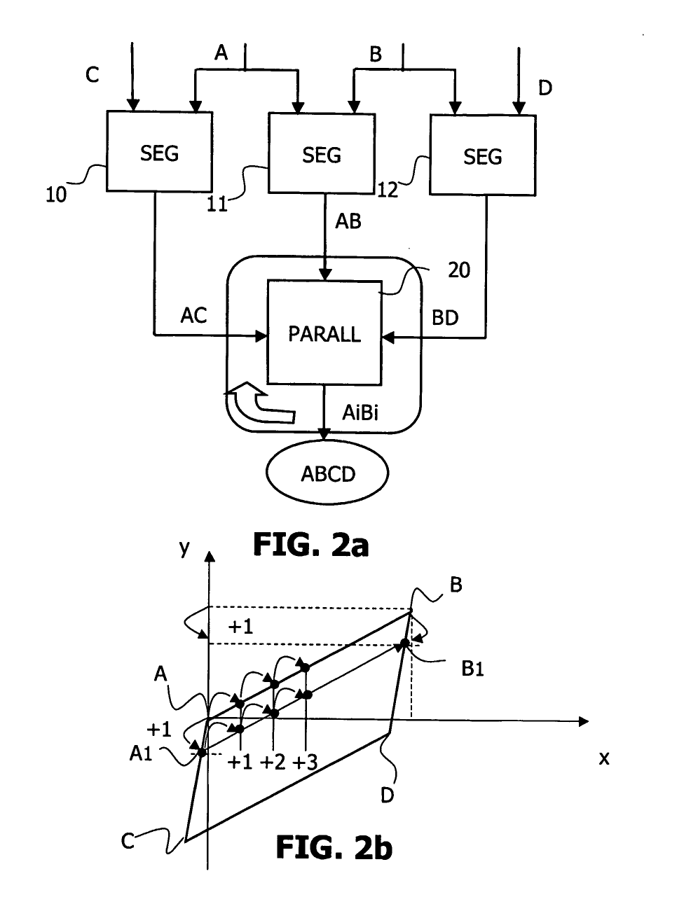

The method according to the invention is presented in a functional manner in FIG. 2a. It comprises a step 10 of calculating the coordinates of the points of the first segment AB. Hereinafter, for reasons of simplicity of writing, the term AB will be given to all the coordinates of the points forming the segment AB, {(x_{A}, y_{A}),(x₁, y₁),(x₂, y₂), . . . , (x_{B}, y_{B})} in a reference frame (Ax, Ay) with the first vertex A as its origin. The set formed by the points on the first segment AB is therefore expressed as follows: AB={(0,0),(x₁, y₁),(x₂,y₂), . . . , (x_{B}, y_{B})}.

The method according to the invention also comprises a step 11 of calculating the coordinates of the points on the second segment AC and a step 12 of calculating the coordinates of the points on the third segment BD.

Advantageously, this calculation of the coordinates is done according to an algorithm known as Bresenham's algorithm or mid-point algorithm. Such an algorithm makes it possible in particular to trace an oblique segment on the discrete grid of a graphics screen. The verb “trace” means here determining the points on the discrete grid forming a discrete approximation of the oblique segment.

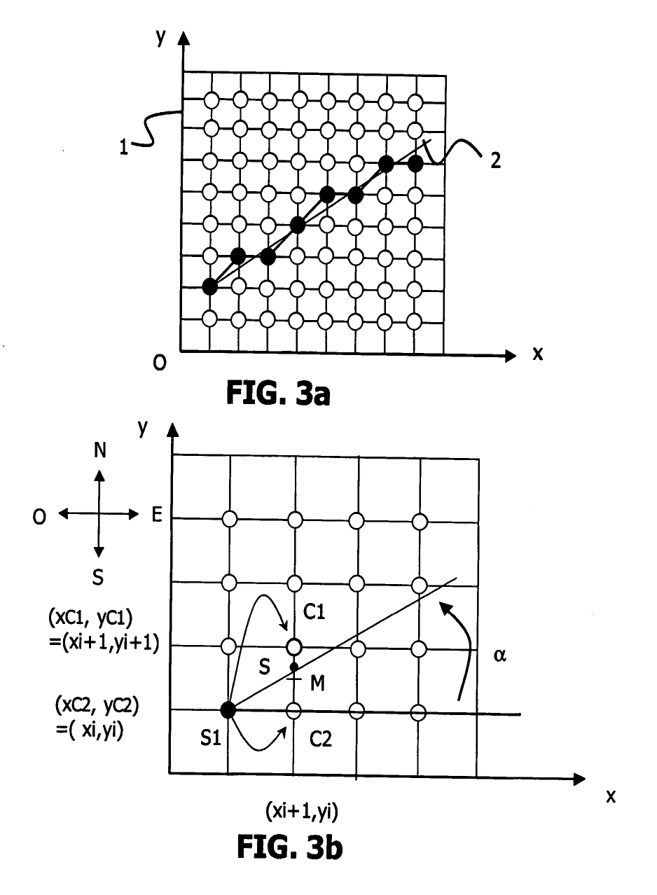

The principle of Bresenham's algorithm is presented in FIGS. 3a and 3b. In FIG. 3a, a discrete grid 1 is depicted, referenced by a reference frame (Ox, Oy) and cut by an oblique segment 2. The algorithm proceeds as illustrated by FIG. 3b:

the choice of a favored direction. This choice depends on a measurement α of the slope of the segment 2. If this slope is less than 45 degrees, the axis Ox is chosen, otherwise it is the axis Oy. In the example in FIG. 2b, it is the axis Ox, starting from one end S₁ of the segment, incrementation of the coordinate x_{S1} along the axis of the favored direction Ox. A point S belonging to the segment 2 such that x_{S}=x_{S1}+1 is considered. It is a case of determining which point on the grid 1 is closest to S. Two points are candidates: the point C₁ situated to the north-east of S₁, such that x_{C1}=x_{S1}+1 and y_{C1}=y_{S1}+1 and the point E situated to the east of S₁ such that x_{C2}=x_{S1}+1 and y_{C2}=y_{S1}.

considering a middle point M of the segment C₁C₂, the differences Δ₁=y_{C1}−y_{M} and Δ₂=y_{M}−y_{C2} are evaluated. If Δ₁<Δ₂, C₁ is chosen as an approximation of the point S, otherwise C₂ is chosen as an approximation of the point S,

the operation is repeated for all the points on the oblique segment 2. A broken line 3 is obtained as a succession of related points in the sense of a relatedness 8, that is to say a relatedness which considers that a point has eight neighbors.

An example of an implementation of a “line” function intended to trace a segment using Bresenham's algorithm is presented below in C language:

```
    static
    void line(int xi,int yi, int xf,int yf) {
      int dx,dy,i,xinc,yinc,cumul,x,y ;
      x = xi ;
      y = yi ;
      dx = xf − xi;
      dy = yf − yi;
      xinc = (dx > 0 ) ? 1 : −1 ;
      yinc = (dy > 0 ) ? 1 : −1 ;
      dx = abs(dx) ;
      dy = abs(dy) ;
      printf (“%d, %d\n”, x,y) ;
      if ( dx > dy ) {
        cumul = dx / 2 ;
      for ( i = 1 ; i <= dx ; i++ ) {
        x += xinc ;
        cumul += dy ;
        if (cumul >= dx) {
          cumul −= dx ;
          y += yinc ;
        }
      printf (“%d, %d\n”, x,y) ;
    }
  }
  else {
    cumul = dy / 2 ;
    for ( i = 1 ; i <= dy ; i++ ) {
      y += yinc ;
      cumul += dx ;
      if ( cumul >= dy ) {
        cumul −= dy ;
        x += xinc ;
      }
      printf (“%d, %d\n”, x,y) ;
    }
  }
}
```

This example shows the simplicity of this algorithm, which uses only integer values and no multiplication and is summarized in a few lines of code. One advantage of Bresenham's algorithm is being well adapted to hardware implementation.

However, the invention is not limited to the use of this algorithm, but relates to any other method of tracing an oblique segment. There exist segment tracing methods which associate a word with this segment, the calculation of this word being based on the Freeman code of the connections between two consecutive points on this segment. Amongst these, the Castle method is described by Castle in the document “An application of Euclid's algorithm to drawing straight lines”, published in “Fundamental Algorithms in Computer Graphics” by Springer-Verlag in 1985, at pages 135 to 139. One drawback of these methods is being more complex to implement than Bresenham's algorithm.

FIG. 2b illustrates an example of a parallelogram ABCD, the first, second and third segments, AB, AC and BD, of which are traced by means of Bresenham's algorithm. In this example, the first segment AB is traced by taking the horizontal axis Ax as the favored direction, whilst the second and third segments AC and BD are traced by taking the vertical axis Ay as the favored direction.

At the end of the three steps 11, 12 and 13, the traces of the first, second and third segments AB, AC and BD are known. All the points on the discrete grid forming these three segments are therefore perfectly determined by their coordinates in the reference frame (Ax, Ay).

Finally, the method according to the invention comprises a step 20 of tracing all the segments parallel to the first segment AB and included within the parallelogram ABCD.

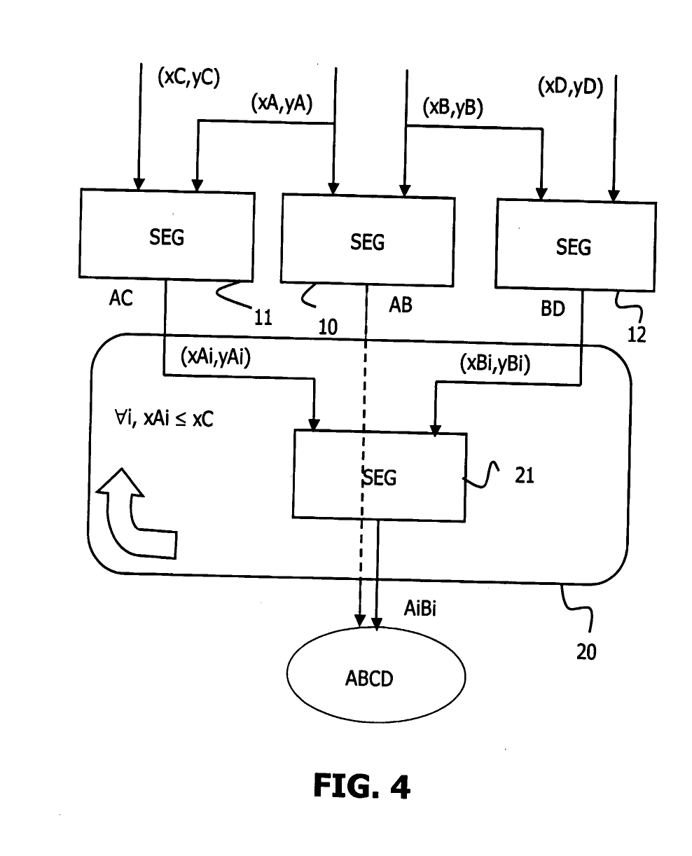

In a first embodiment of the invention, described by the functional diagram in FIG. 4 and illustrated by the example in FIG. 2b, said step 20 comprises a substep 21 of calculating the coordinates of a segment included between a point Aᵢ belonging to the second segment AC and a point Bᵢ belonging to the third segment BD, Aᵢ and Bᵢ being situated at the same distance from A and B respectively. The substep 21 is iterated in order to trace all the segments AᵢBᵢ situated within the parallelogram ABCD and at equal distances from A and B respectively in a horizontal or vertical favored direction. In the example in FIG. 2b, the favored direction of the segments AC and BD is the vertical axis Ay. Starting from xA, the point A₁ of the second segment AC is considered, such that y_{A1}=y_{A}+1 and the corresponding point B₁ of the third segment BD, such that y_{B1}=y_{B}+1. The second and third segments AC and BD being parallel, the points A₁ and B₁ are at equal distances from A and B respectively along the axis Ay.

Advantageously, the substep 21 uses Bresenham's algorithm for calculating the coordinates of the points on the segment A₁B₁. The operation is repeated for all the segments AᵢBᵢ such that yAᵢ≦yC, that is to say until all the parallelogram has been traveled over.

An example of implementation of a “parallelogram” function intended to fill in a parallelogram using the previously described “line” function, is presented below:

```
  static void parallelogram(int xa,int ya, int xb,int yb, int xc, int yc, int
xd, int yd) {
    int x_ab,y_ab,x_cd,y_cd,i,xinc,yinc,dx,dy,cumul ;
      x_ab = xa ;
      y_ab = ya ;
      x_cd = xc ;
      y_cd = yc ;
      dx = xb − xa;
      dy = yb − ya;
      xinc = ( dx > 0 ) ? 1 : −1 ;
      yinc = ( dy > 0 ) ? 1 : −1 ;
      dx = abs(dx) ;
      dy = abs(dy) ;
    line (x_ab, y_ab, x_cd, y_cd);
    printf (“\n”);
    if ( dx > dy ) {
      cumul = dx / 2 ;
      for ( i = 1 ; i <= dx ; i++ ) {
        x_ab += xinc ;
        x_cd += xinc ;
        cumul += dy ;
      if (cumul >= dx) {
        cumul −= dx ;
        y_ab += yinc ;
        y_cd += yinc ;
      }
      line (x_ab, y_ab, x_cd, y_cd);
      printf (“\n”);
    }
  }
  else {
    cumul = dy / 2 ;
    for ( i = 1 ; i <= dy ; i++ ) {
      y_ab += yinc ;
      y_cd += yinc ;
      cumul += dx ;
      if ( cumul >= dy ) {
        cumul −= dy ;
        x_ab += xinc ;
        x_cd += xinc ;
      }
      line (x_ab, y_ab, x_cd, y_cd);
      printf (“\n”);
    }
  }
}
```

One advantage of this first embodiment of the invention is that it is very simple. As the “parallelogram” function example presented below shows, Bresenham's algorithm uses only integer values and simple operations, limited to additions and comparative tests. Such an algorithm is therefore compatible with execution in real time and well adapted to hardware implementation, as required by the production of a video game for example.

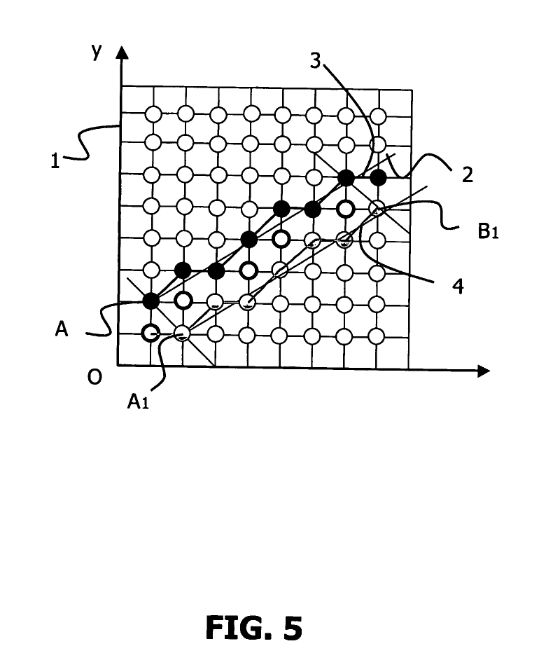

One drawback of this first embodiment of the invention is that it does not guarantee an exhaustive travel over all the points on the discrete grid used in the parallelogram. This is because Bresenham's algorithm is based on an approximation, which gives rise to an error. In FIG. 3b, the ordinate y_{S} of the point S of the segment 2 is replaced by the integer ordinate y_{C1}. The error committed is equal to y_{C1}−y_{S}. In generating several oblique segments side by side by means of Bresenham's algorithm, the substep 21 accumulates the errors of this type, which means that certain points on the discrete grid, although included in the parallelogram, are not on the trace of any segment AᵢBᵢ. Such errors are illustrated by FIG. 5. Between the segment traced between the points A₁ and B₁ and the segment traced between the points A and B there are points which are not traveled over by any segment of the parallelogram ABCD, although they belong to the parallelogram ABCD.

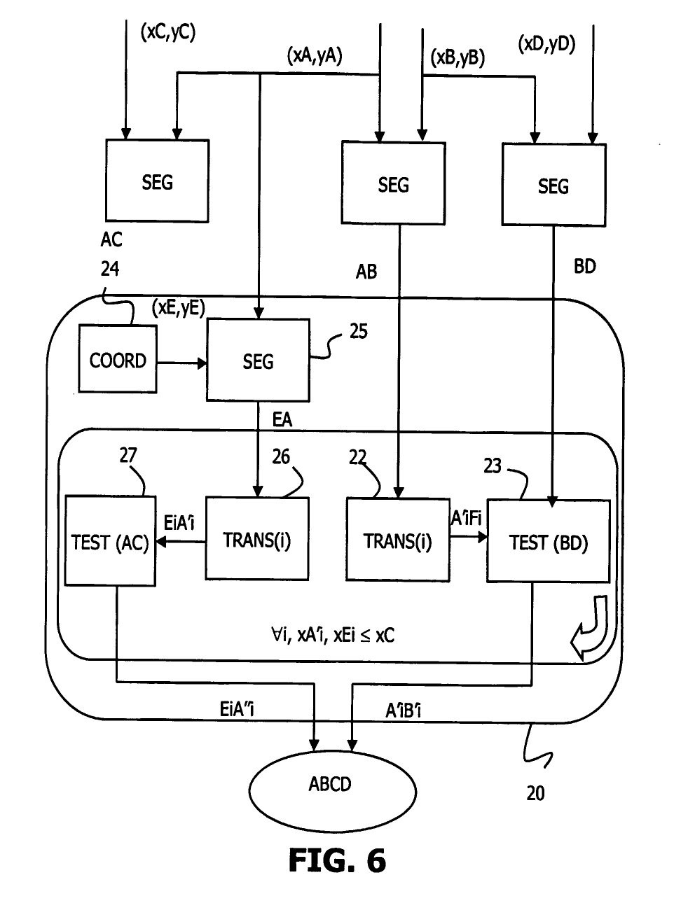

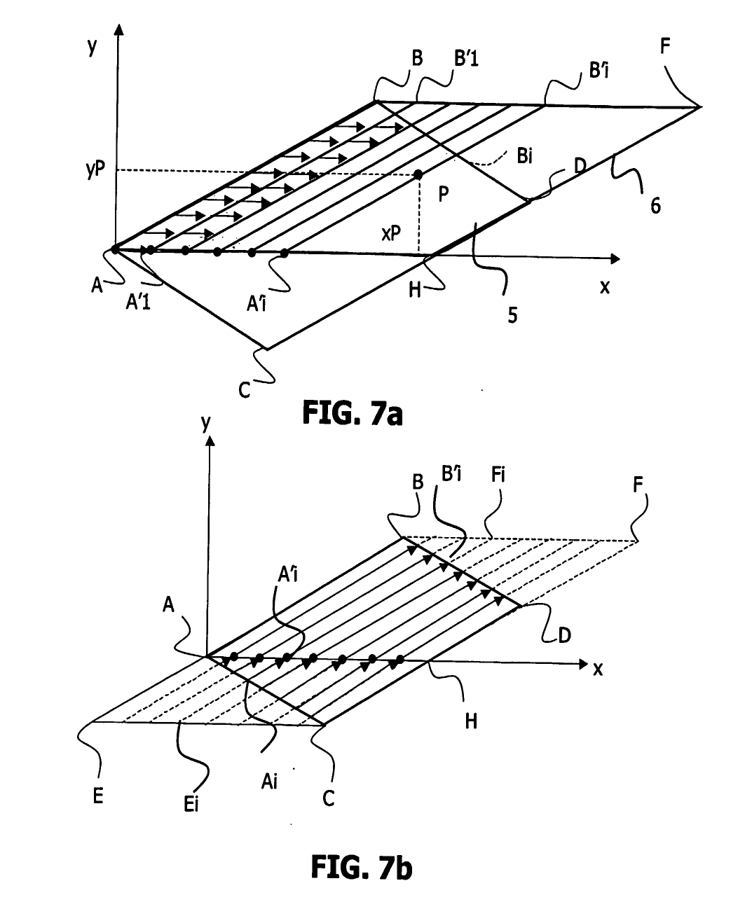

In a second embodiment of the invention, presented functionally in FIG. 6, step 20 comprises a substep 22 of translation of the first segment AB in a horizontal and vertical favored direction, intended to supply a translated segment included in the parallelogram ABCD. This translation subset 22 consists of calculating the coordinates of a segment parallel to the first segment AB by translation in a horizontal or vertical favored direction. FIG. 7a presents an example of horizontal translations of the segment AB along the axis Ax inside the parallelogram ABCD. Such translations are very simple to implement. Consider in fact a segment A′₁B′₁ translated horizontally by one unit in the direction of the positive x's. This gives simply x_{A′1}=x_{A}+1 and y_{A′1}=y_{A}. In this way, all the possible translated segments A′ᵢB′ᵢ, such as x_{A}<x_{A′}≦x_{C} are traced. A parallelogram 6 is formed. Only the points belonging to a surface 5 common to the parallelogram 6 with the parallelogram ABCD must be taken into account. To do this, step 20 comprises a test substep 23 intended to test whether or not a point P on a translated segment A′ᵢB′ᵢ belongs to the parallelogram ABCD. Said step consists of verifying that the ordinate x_{P} of the point P is less than the ordinate y_{Bi} of the point Bᵢ of the segment BD such that x_{Bi}=x_{B}+(x_{Ai}−x_{A′i}). As shown by FIG. 7a, such translations of the first segment AB in a favored direction do not make it possible to fill in all the parallelogram ABCD. In FIG. 7a, consider the point H of intersection of the axis Ax with the segment CD. The triangle formed by the vertices ACH remains to be filled in. For this purpose, with reference to FIG. 7b, the point E obtained by projection of the third vertex C onto the extension of the segment AB is considered, which will be designated by the straight line (AB), in the favored direction Ax. Step 20 also comprises a substep 24 of calculating the coordinates of said projection point E. This calculation can be done in various ways. A first solution consists of considering the vectors

$$A {B}^{->} = ( \begin{matrix}{x}_{B} - {x}_{A} \\ {y}_{B} - {y}_{A}\end{matrix} ) = ( \begin{matrix}{x}_{B} \\ {y}_{B}\end{matrix} )$$

and

$$E {A}^{->} = ( \begin{matrix}{x}_{A} - {x}_{E} \\ {y}_{A} - {y}_{E}\end{matrix} ) = ( \begin{matrix}- {x}_{E} \\ {y}_{E}\end{matrix} ) .$$

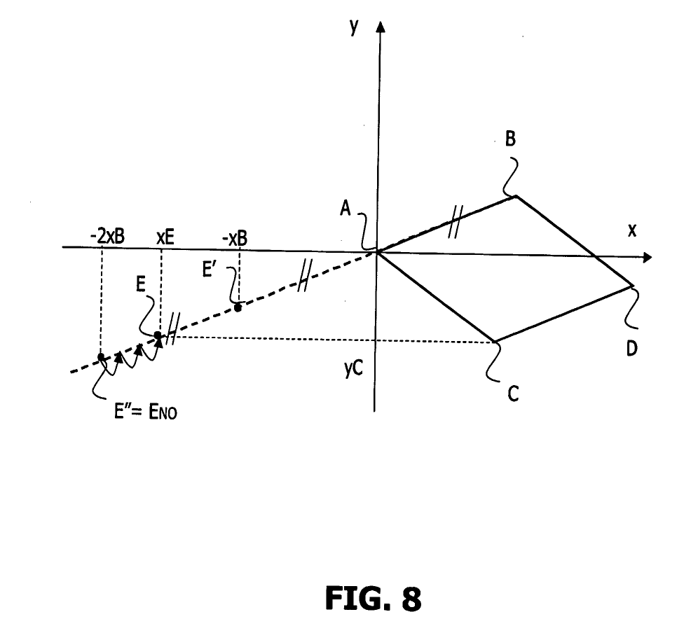

The vectors A\vec{B} and E\vec{A} being parallel, the equation −x_{B}.y_{E}−y_{B.}(−x_{E})=0 well known to persons skilled in the art, is satisfied. Knowing that y_{E}=y_{C}, since E is the projection of C along the axis Ax, the abscissa of E is equal to x_{E}=(x_{B}.y_{C})/yB. One advantage of this solution is to be based on a very simple relationship. A major drawback is that it uses a division, which is very expensive in terms of calculation cycles on a processor. By way of alternative, a more algorithmic method comprising two steps can be used. An example is presented in FIG. 8. A first step consists of determining a non-optimal position E_{NO} of E on the straight line (AB). It is described as follows:

```
xE_{NO} = yE_{NO} = 0;
do {
    xE_{No} +=−|x_{B}−x_{A}|;
    yE_{NO} +=1|y_{B}−y_{A}|;
}
while (|yE_{NO}| ≦ |y_{C}|);
```

The point E′ symmetrical with the point B with respect to the point A is considered. If this point E′ has an ordinate greater than that of C in absolute value, E_{NO} is taken to be equal to the point E′, otherwise the point E″ symmetrical with A with respect to E′ is considered and so on until the condition |yE_{NO}|≦|y_{C}| is satisfied.

A second step consists of refining the position of the point E on a straight line (AB) by determining the coordinates of the points of the segment E_{NO}A according to Bresenham's algorithm. Starting from A, it is a question of traveling over the segment AE_{NO} as far as the point E, that is to say as far as the point on the segment E_{NO}A of ordinate equal to y_{C}.

One advantage of this second method is not using division.

Step 20 next comprises a substep 25 of calculating the coordinates of the points of a segment EA formed by the projection E and the first vertex A. Like the steps implemented previously for tracing oblique segments, the said substep 25 advantageously uses Bresenham's algorithm.

A substep 26 of translating the segment EA in the favored direction is intended to supply a segment EᵢA′ᵢ parallel to the segment EA, according to a principle similar to that previously described for the step 22 of translating the segment AB. In the same way as before for the segment AB, the substep 26 is combined with a test substep 27, intended to test whether a point P on a segment EᵢA′ᵢ translated from EA is included in the parallelogram ABCD.

The successive translations of the segments AB and EA along the axis Ax over a distance corresponding to the segment AC make it possible to travel over all the points on the parallelogram ABCD. One advantage of this second embodiment is that it provides an entire filling in of the parallelogram ABCD. It can be considered that the operations used for performing a translation of a segment and testing whether its points are included in the parallelogram have a complexity equivalent to those used by Bresenham's algorithm for tracing an oblique segment between two known points. On the other hand, the step of calculating the projection point E makes this second embodiment a little more complex than the first. However, as shown by the example implementation presented below, the second embodiment remains relatively simple to implement.

```
void parallelogram(int Ax,int Ay, int Bx,int By,
                int Cx, int Cy, int Dx, int Dy) {
  int AB_dx, AB_dy, AB_max, AB_xinc, AB_yinc,
    AB_cumul, AB_i, AB_x, AB_y, AB_mode;
  int AC_dx, AC_dy, AC_max, AC_xinc, AC_yinc,
      AC_cumul, AC_i, AC_x, AC_y, AC_mode ;
  int EA_dx, EA_dy, EA_max, EA_xinc, EA_yinc,
    EA_cumul, EA_i, EA_x, EA_y, E_ok, Ex, Ey, EA_mode ;
  int BF_dx, BF_dy, BF_max, BF_xinc, BF_yinc,
    BF_cumul, BF_i, BF_x, BF_y, F_ok, Fx, Fy, BF_mode ;
  int x, y;
  int transVertical, transHorizontal;
  // Determine the vertical or horizontal translation of the segment AB
  transVertical = 0;
  transHorizontal = 0;
  if (abs(Bx − Ax) > abs(By − Ay)) {
    if ( Cy > Ay) transVertical = 1 ;
    else transVertical = −1 ;
  }else {
    if ( Cx > Ax) transHorizontal = 1;
    else transHorizontal = −1;
  }
  //
  // Determine the position of E or F if necessary
  // if the translation of AB is horizontal
  // E is the horizontal projection of C on the segment AB,
  // F is the horizontal projection of D on the segment AB,
  // if the translation of AB is vertical
  // E is the vertical projection of C on the segment AB
  // F is the vertical projection of D on the segment AB,
  // E and F must be outside the segment AB
  if (((transVertical!= 0)&&( Cx < Ax ))||
    ((transHorizontal!= 0)&&( Cy < Ay ))) {
    E_ok = 1;
  }
  else{
    E_ok = 0;
  }
  if (((transVertical!=0)&&( Cx > Ax ))||
    ((transHorizontal!=0)&&( Cy > Ay )))
    F_ok = 1;
  else
  F_ok = 0;
  AB_x = Ax ;
  AB_y = Ay ;
  init(Ax, Ay, Bx, By, &AB_dx, &AB_dy, &AB_xinc, &AB_yinc,
    &AB_cumul, &AB_max, &AB_mode);
  for ( AB_i = 1 ; AB_i <= AB_max+1 ; AB_i++ ) {
    if (transVertical != 0) {
      if ((F_ok == 1) && (AB_x == Cx)) {
      Fx = Dx;
      Fy = By + (AB_y − Ay);
    }
      if ((E_ok == 1) && (AB_x == Dx)){
      Ex = Cx;
      Ey = Ay − (By − AB_y);
    }
  }else if ((transHorizontal != 0)){
    if ((F_ok == 1) && (AB_y == Cy)){
      Fx == Bx + (AB_x − Ax);
      Fy = Dy;
    }
    if ((E_ok == 1) && (AB_y == Dy)){
      Ex = Ax − (Bx − AB_x);
      Ey = Cy;
    }
  }
  next(AB_mode, AB_xinc, AB_yinc, AB_dx, AB_dy,
    &AB_cumul, &AB_x, &AB_y) ;
  }
  //
  // Bresenham on the segment AC
  AC_x = Ax ;
  AC_y = Ay ;
  init(Ax, Ay, Cx, Cy, &AC_dx, &AC_dy, &AC_xinc &AC_yinc,
    &AC_cumul, &AC_max, &AC_mode);
  for ( AC_i = 1; AC_i <= AC_max+1; AC_++ ){
    printf(“\n %dnd line: ”, AC_i);
  //
  // Bresenham on the segment EA
    if ( E_ok == 1 ){
      EA_x = Ex ;
      EA_y = Ey ;
      init(Ex, Ey, Ax, Ay, &EA_dx, &EA_dy, &EA_xinc,
      &EA_yinc, &EA_cumul, &EA_max, &EA_mode);
      for ( EA_i = 1 ; EA_i <= EA_max ; EA_i++ ) {
    x = EA_x;
    y = EA_y;
    if ((transVertical == −1))
      y = EA_y − AC_i − transVertical;
    else if (transVertical == 1)
      y = EA_y + AC_i − transVertical;
    if ((transHorizontal == −1))
      x = EA_x − AC_i − transHorizontal;
    else if (transHorizontal == 1)
      x = EA_x + AC_i − transHorizontal;
    test(transVertical, transHorizontal,
      AB_dx, AB_dy, AC_x, AC_y, x, y);
    next(EA_mode, EA_xinc, EA_yinc, EA_dx, EA_dy,
      &EA_cumul, &EA_x, &EA_y) ;
  }
  }
    //
    // Bresenham on the segment AB
    AB_x = Ax ;
    AB_y = Ay ;
    init(Ax, Ay, Bx, By, &AB_dx, &AB_dy, &AB_xinc, &AB_yinc,
      &AB_cumul, &AB_max, &AB_mode)z;
    for ( AB_i = 1 ; AB_i <= AB_max+1 ; AB_i++ ) {
      x = AB_x;
      y = AB_y;
      if (transVertical == −1 )
        y = AB_y − AC_i − transVertical;
      else if (transVertical == 1)
        y = AB_y + AC_i − transVertical;
      if (transHorizontal == −1)
        x = AB_x − AC_i − transHorizontal;
      else if (transHorizontal == 1)
        x = AB_x + AC_i − transHorizontal;
      test(transVertical, transHorizontal,
        AB_dx, AB_dy, AC_x, AC_y, x, y);
      next(AB_mode, AB_xinc, AB_yinc, AB_dx, AB_dy,
        &AB_cumul, &AB_x, &AB_y);
    }
  //
  // Bresenham on the segment BF
  if (F_ok == 1){
    BF_x = Bx ;
    BF_y = By ;
    init(Bx, By, Fx, Fy, &BF_dx, &BF_dy, &BF_xinc, &BF_yinc,
    &BF_cumul, &BF_max, &BF_mode);
    for ( BF_i = 1 ; BF_i <= BF_max+1 ; BF_i ++ ) {
    next(BF_mode, BF_xinc, BF_yinc, BF_dx, BF_dy,
      &BF_cumul, &BF_x, &BF_y ) ;
    x = BF_x;
    y = BF_y;
    if (transVertical == −1)
          y = BF_y − AC_i − transVertical;
        else if (transVertical == 1)
        y = BF_y + AC_i − transVertical;
        if ((transHorizontal == −1))
          x = BF_x − AC_i − transHorizontal;
        else if (transHorizontal == 1)
          x = BF_x + AC_i − transHorizontal;
        test(transVertical, transHorizontal,
          AB_dx, AB_dy, AC_x, AC_y, x, y);
      }
    }
    printf (“\n”) ;
    next(AC_mode, AC_xinc, AC_yinc, AC_dx, AC_dy,
      &AC_cumul, &AC_x, &AC_y ) ;
  }
}
```

It is possible to implement the processing method according to the invention by means of a suitably programmed circuit. A computer program contained in a programming memory can cause the circuit to perform the various operations described above with reference to FIGS. 4 and 6. The computer program can also be loaded into the programming memory by the reading of a data medium such as for example a disk which contains said program. The reading can also take place by means of a communication network such as for example the Internet. In this case, a service provider will make the computer program available to interested parties in the form of a downloadable signal.

The invention is not limited to the embodiments which have just been described by way of example. Modifications or improvements can be made thereto whilst remaining within the scope of the invention. In particular, other imaging modes, such as magnetic resonance imaging or positron emission tomography, can be used. In the present text, the verb “comprise” is used to signify that the use of other elements, means or steps is not excluded.

1. A method of filling in a parallelogram (ABCD) comprising a first vertex (A), a second vertex (B), a third vertex (C) and a fourth vertex (D), said method comprising:
a step (10) of calculating the coordinates of the points on a first segment (AB) between the first vertex (A) and the second vertex (B),
a step (11) of calculating the coordinates of the points on a second segment (AC) between the first vertex (A) and the third vertex (C),
a step (12) of calculating the coordinates of the points on a third segment (BD) between the second vertex (BD) and the fourth vertex D,
an iterative step (20) of calculating the coordinates of the points on a segment parallel to the first segment AB and included within the parallelogram ABCD.

2. A method of filling in a parallelogram (ABCD) as claimed in claim 1, characterized in that said iterative step (20) of calculating the coordinates of the points on a segment parallel to the first segment (AB) also comprises a substep (21) of calculating coordinates of the points on a segment lying between a point (Aᵢ) belonging to the second segment (AC) and a point (B1) belonging to the third segment (BD), the points (Aᵢ) and (Bᵢ) being situated at the same distance from the first vertex (A) and from the second vertex (B) respectively, in a horizontal (Ax) or vertical (Ay) favored direction.

3. A method of filling in a parallelogram (ABCD) as claimed in claim 1, characterized in that said iterative step (20) of calculating the coordinates of a segment parallel to the first segment AB comprises a substep (22) of translating the first segment (AB) in a horizontal or vertical favored direction, intended to supply a translated segment A′ᵢB′ᵢ included in the parallelogram (ABCD), and a test substep (23) intended to test whether a point (P) on the translated segment (A′ᵢB′ᵢ) is included in the parallelogram ABCD.

4. A method of filling in a parallelogram (ABCD) as claimed in claim 3, characterized in that said iterative step (20) of calculating the coordinates of the points on a segment parallel to the first segment (AB) also comprises:
a substep (24) of calculating the coordinates of a projection (E) of the third vertex (C) on an extension of the first segment (AB) and parallel to the favored direction,
a substep (25) of calculating the coordinates of the points of a segment (EA) formed by the projection (E) and the first vertex (A),
a substep (26) of translating the segment (EA) in the favored direction, intended to supply a segment (EᵢA′ᵢ) parallel to the segment (EA),
a test substep (27) intended to test whether a point (P) on a segment (EᵢA′ᵢ) translated from (EA) is included in the parallelogram (ABCD).

5. A method of filling in a parallelogram (ABCD) as claimed in claim 1, characterized in that said steps of calculating coordinates of the points on a segment use a mid-point algorithm.

6. A system for tracing and filling in a parallelogram (ABCD) for a graphics screen, intended to supply the coordinates of points included in the parallelogram from the coordinates of a first vertex (A), a second vertex (B), a third vertex (C) and a fourth vertex (D), said system comprising:
means (10) for calculating the coordinates of the points on a first segment between the first vertex A and the second vertex B,
means (11) for calculating the coordinates of the points on a second segment between the first vertex A and the third vertex C,
means (12) for calculating the coordinates of the points on a third segment BD between the second vertex B and the fourth vertex D,
iterative means (20) for calculating the coordinates of the points on a segment parallel to the first segment AB and included within the parallelogram ABCD.

7. A computer program product comprising a set of instructions which, when they are loaded into a circuit, cause the latter to implement the method as claimed in claim 1.
